(19) United States
(12) Patent Application Publication
(10) Pub. No.: US 2006/0065695 A1
(43) Pub. Date: Mar. 30, 2006

(54) Wire feed system for a wire bonding apparatus

(75) Inventor: Edward T. Laurent, Amblerr, PA (US)

Correspondence Address: KULICKE AND SOFFA INDUSTRIES, INC., 2101 BLAIR MILL ROAD, WILLOW GROVE, PA, 19090, US

(73) Assignee: Kulicke and Soffa Industries, Inc.

(21) Appl. No.: 11/234,961

(22) Filed: Sep. 26, 2005

Related U.S. Application Data
(60) Provisional application No. 60/613,365, filed on Sep. 27, 2004.

(51) Int. Cl. B23K 37/00

(52) U.S. Cl. 228/4.5

(57) ABSTRACT

A wire feed system for a wire bonding apparatus is provided. The wire feed system includes a spool for storage of a wire, a wire tensioner, and a wire guide adapted to form the wire into a predetermined configuration between the spool and the wire tensioner. The wire tensioner and the wire guide are supported such that relative movement between the wire tensioner and the wire guide during a wire bonding procedure is substantially prevented.

### RELATED APPLICATION

This application is related to and claims priority from U.S. Provisional Application No. 60/613,365, filed Sep. 27, 2004, entitled “Wire Feed System For A Wire Bonding Apparatus”, the disclosure of which is incorporated herein by reference in its entirety.

### FIELD OF THE INVENTION

The present invention relates to wire bonding, and more particularly, to a wire feed system for a wire bonding apparatus.

### BACKGROUND OF THE INVENTION

In the electronics industry, conductive metal wire is used in a variety of devices, such as semiconductor devices, for example, to connect portions of the device. Exemplary materials used for wire bonding include gold, aluminum, copper, and silver. A wire bond is formed by attaching a length of wire between two contact locations. In order to form the attachment, various devices are used to sever and bond (e.g., melt) the wire ends to the contact location. Known wire bonding apparatuses include thermocompression (T/C), thermosonic (T/S) or ultrasonic (U/S) devices. The resulting length of bonded wire is typically curved along its length (e.g., in a generally parabolic or elliptical configuration) and is, therefore, referred to as a wire “loop”.

Wire bonding apparatuses include a wire feed system, as disclosed in U.S. Pat. No. 5,402,927 to Frasch (i.e., the '927 patent), which supplies wire to a bonding tool (e.g., a capillary) carried by the bond head of the apparatus. The wire feed system of the '927 patent includes a spool on which a length of fine wire is wound to provide a supply of wire for the capillary. The spool is rotatably supported for unwinding the wire from the spool as needed by the bond head of the bonding apparatus.

The wire feed system of the '927 patent includes an air guide that directs a stream of air against a portion of wire unwound from the spool to form the portion of wire into a curved configuration. The curved wire configuration provided by the air guide, which results in substantially constant tension throughout the wire portion, is sometimes referred to in the art as a “slack loop.” The wire is then directed from the air guide of the wire feed system to a wire tensioner carried by the bond head. The wire tensioner increases the tension applied to the wire before it reaches the capillary.

Exemplary bond heads of wire bonding apparatuses are motor-driven for movement of the bond head along both the X and Y axes of a XY bond plane. The wire spool and air guide of the prior wire feed systems, however, are not carried by the bond head. As a result, there is relative movement between the components of the wire feed system, which are fixed with respect to the XY plane, and the bond head. The relative movement between the feed system components and the bond head increases the length of wire that is pulled from the spool. The relative movement also undesirably works the metal wire before the wire reaches the capillary of the bonding apparatus.

Thus, it would be desirable to provide a wire feed system for a wire bonding apparatus in which certain components of the wire feed system are carried by the bond head of the bonding apparatus, thereby limiting relative movement between the bond head and the wire feed system components during movement of the bond head.

### SUMMARY OF THE INVENTION

According to an exemplary embodiment of the present invention, a wire feed system for a wire bonding apparatus is provided. The wire feed system includes a spool for storage of a wire, a wire tensioner, and a wire guide adapted to form the wire into a predetermined configuration between the spool and the wire tensioner. The wire tensioner and the wire guide are supported such that relative movement between the wire tensioner and the wire guide during a wire bonding procedure is substantially prevented.

According to another exemplary embodiment of the present invention, a bond head for a wire bonding machine is provided. The bond head includes a spool for storage of wire and a first moveable support structure configured for moving at least a portion of the bond head along a first axis. The portion of the bond head includes the spool.

According to yet another exemplary embodiment of the present invention, a wire bonding apparatus is provided. The wire bonding apparatus includes a bond head including a capillary adapted to receive a wire. The bond head is movably supported for translation in an X-Y working plane during a wire bonding procedure. The wire bonding apparatus also includes a wire tensioner for tensioning the wire received by the capillary as the capillary moves in the X-Y plane. The wire bonding apparatus also includes a wire guide adapted to form the wire into a predetermined configuration. The wire guide and the wire tensioner are supported with the bond head for movement with respect to the X-Y working plane so as to substantially inhibit relative movement between the wire guide and the wire tensioner during a wire bonding procedure.

According to yet another exemplary embodiment of the present invention, a wire feed system for a wire bonding machine is provided. The wire feed system includes a slack loop device including an airflow mechanism adapted to direct a flow of air against a bonding wire received from a wire supply so as to form the wire into a slack loop configuration. The wire feed system also includes a wire tensioner adapted to receive the bonding wire from the slack loop device and apply tension to the bonding wire, the wire tensioner and the slack loop device being supported such that relative movement between the wire tensioner and the slack loop device during a wire bonding procedure is substantially inhibited.

### BRIEF DESCRIPTION OF THE DRAWINGS

For the purpose of illustrating the invention, there is shown in the drawings a form that is presently preferred; it being understood, however, that this invention is not limited to the precise arrangements and instrumentalities shown. In the drawings:

FIG. 1 is a top perspective view of a bond head of a wire bonding apparatus according to an exemplary embodiment of the present invention.

FIG. 2 is a bottom perspective view of the bond head of FIG. 1.

FIG. 3 is a side elevation view of the bond head of FIG. 1.

FIG. 4 is a perspective view of the bond head of FIG. 1 with a portion of the bond head removed to show the wire spool and its mounting structure.

FIGS. 5 and 6 are perspective views of the wire spool and wire spool mounting structure of FIG. 4.

FIG. 7 is a top perspective view of a Y-axis portion of the bond head of FIG. 1 including a slack loop guide and wire tensioner.

FIG. 8 is a rear perspective view of the Y-axis portion of FIG. 7.

FIG. 9 is an enlarged view of a lower front part of the Y-axis portion of FIG. 7.

### DETAILED DESCRIPTION OF THE DRAWINGS

According to certain exemplary embodiments of the present invention, a wire feed system for a wire bonding apparatus includes a spool for winding storage of a wire, a wire tensioner, and a wire guide for forming the wire into a slack loop configuration between the spool and the wire tensioner. For example, the spool may be rotatingly driven by a spool drive motor. The wire tensioner and the wire guide may be supported in a unitary fashion such that relative movement between them during a wire bonding procedure is prevented for reduced working of the wire.

In certain exemplary embodiments, the wire feed system is supported on a support structure including an X-axis portion and a Y-axis portion respectively providing movement along the X and Y axes of an X-Y working plane. For example, each portion of the support structure may include a drive motor. According to one exemplary embodiment, the X-axis portion includes an X-axis slide for slidably supporting the Y-axis portion of the support structure.

Further, the wire guide may include a laminar flow plate defining a laminar flow area and an air supply system may be provided to direct air into the laminar flow area to transversely impinge the wire.

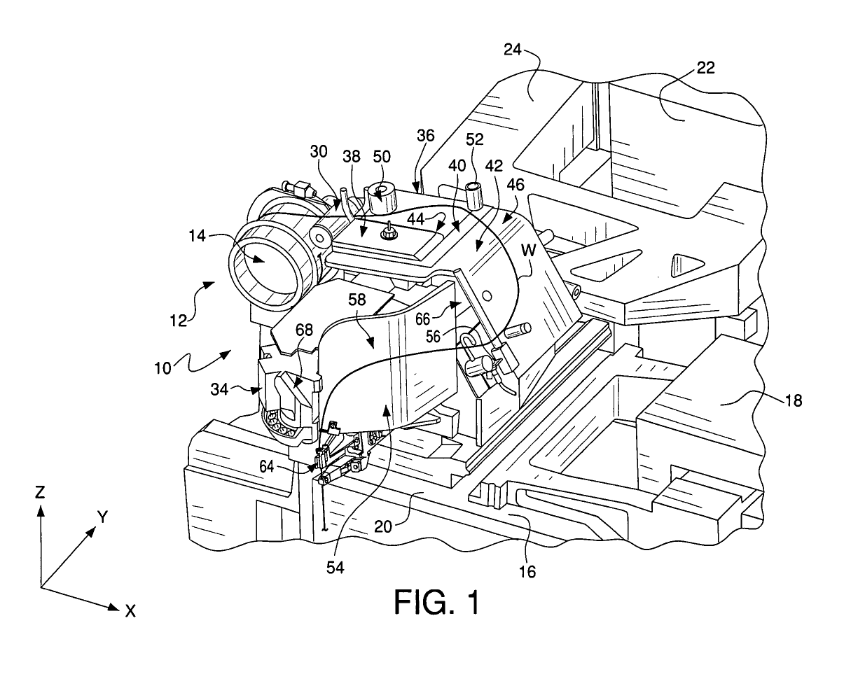

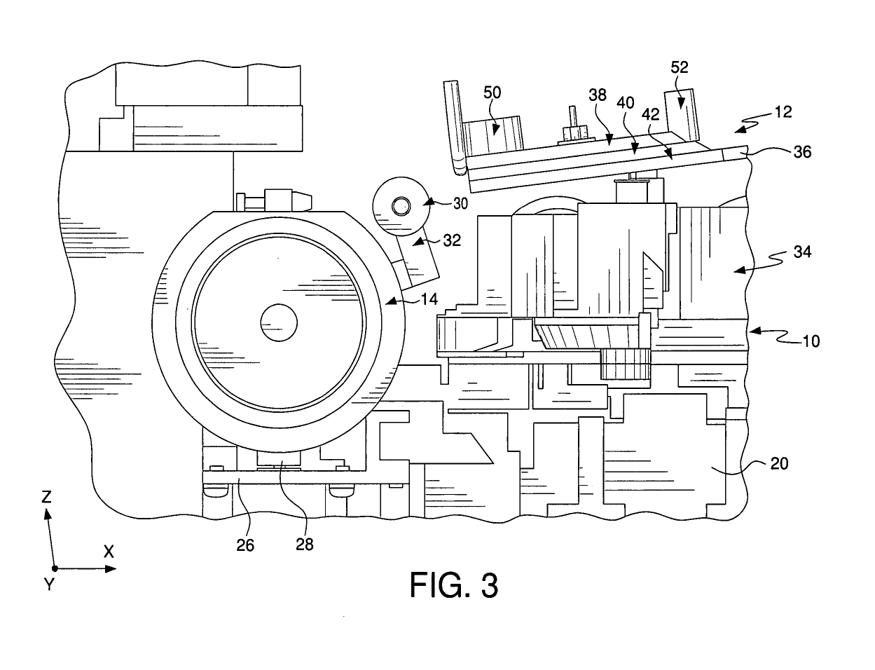

Referring to the drawings, where like numerals identify like elements, there is illustrated in FIGS. 1 through 3 bond head 10 of a wire bonding apparatus according to certain exemplary embodiments of the present invention. The wire bonding apparatus includes wire feed system 12 that includes spool 14. Spool 14 is adapted to support a supply of fine metal wire, W, which is wound onto the spool. Spool 14 is rotatably supported for unwinding the wire W and delivering the wire to a bonding tool (e.g., a capillary) of the bonding apparatus as desired. As described in greater detail below, wire feed system 12 is carried by bond head 10 of the wire bonding apparatus such that relative movement between the components of wire feed system 12 and the capillary of the bond head is significantly reduced. The reduction in relative movement between wire feed system 12 and the capillary significantly reduces the resultant length of wire between spool 14 and the capillary. Shortening of the wire feed length in this manner facilitates greater control over the wire, which promotes higher quality in the resulting wire loops that are formed by the bonding apparatus. The reduction in relative movement between wire feed system 12 and the capillary also desirably reduces the amount of working of the wire through bending associated with the relative movement of the feed system components. Reduction in the working of the metal wire as it is fed from spool 14 to the capillary promotes integrity of the resulting loops formed by the bonding apparatus.

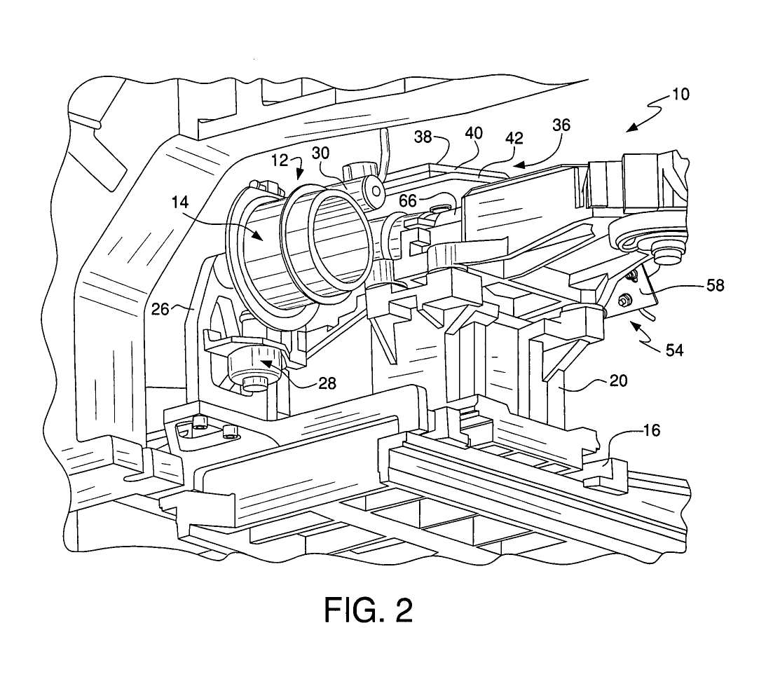

Referring specifically to FIG. 1, bond head 10 includes X-axis slide member 16 and X-axis drive motor 18. X-axis drive motor 18 engages X-axis slide member 16 for translation of X-axis slide member 16 along the X-axis of an XY bond plane. Bond head 10 also includes Y-axis slide casting 20 and Y-axis drive motor 22. Link member 24 connects Y-axis slide casting 20 to Y-axis motor 22. Y-axis drive motor 22 engages link member 24 for translation of Y-axis slide casting 20 along Y-axis of the XY bond plane. As shown in FIGS. 1 and 2, Y-axis slide casting 20 is received on an upper surface of X-axis slide member 16 for sliding translation of Y-axis casting 20 with respect to X-axis slide member 16. X-axis slide member 16 and Y-axis slide casting 20, and associated drive motors 18, 22, provide for translation for the capillary of bond head 10 in the XY bond plane, as described below in greater detail.

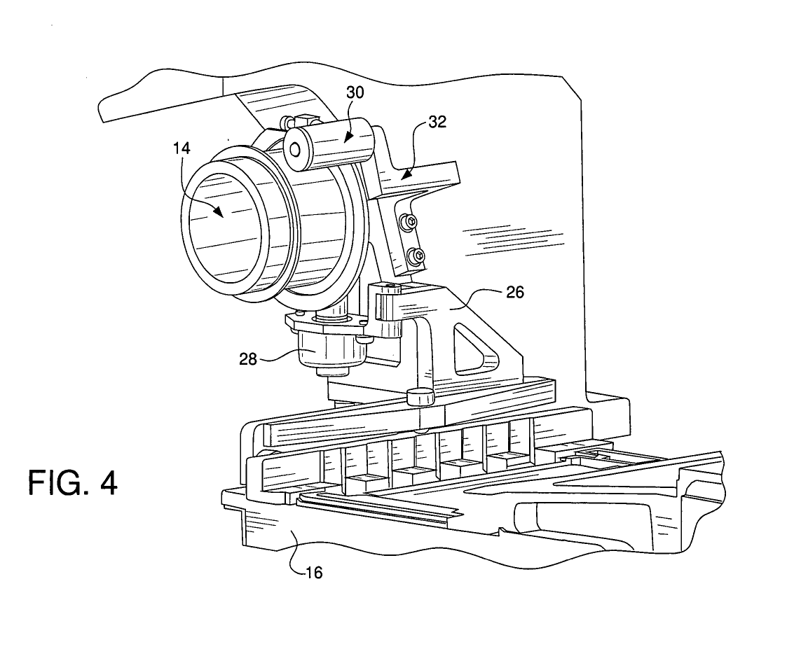

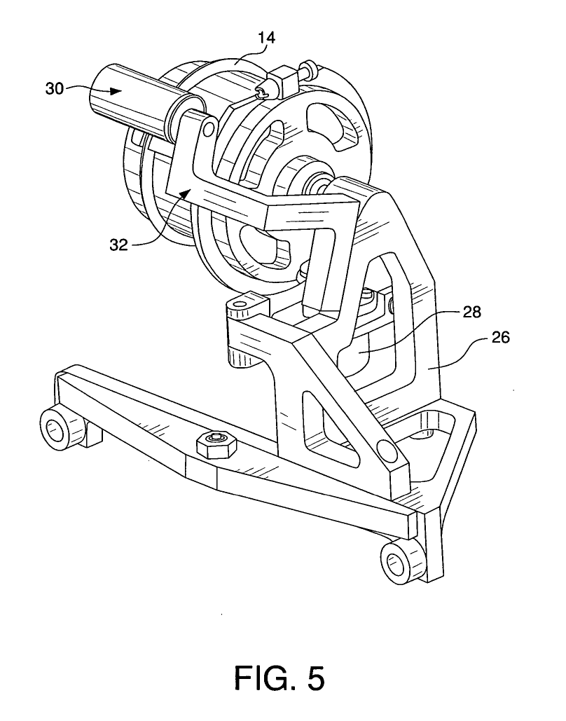

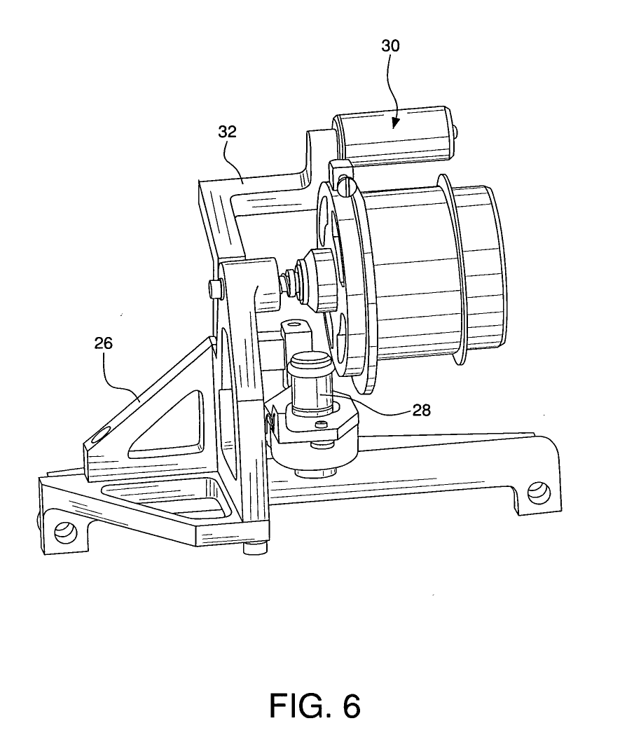

As shown in FIG. 2 and FIGS. 4 through 6, the wire bonding apparatus includes spool mounting structure 26 that rotatably supports spool 14 of wire feed system 12. Y-axis slide casting 20 is removed from FIG. 4 for clarity of view. As shown, spool mounting structure 26 is secured to X-axis slide member 16 (e.g., using fasteners such as bolts) for translation along the X-axis of the XY bond plane. The wire bonding apparatus includes spool drive motor 28 for rotatably driving spool 14. Spool drive motor 28 is secured to spool mounting structure 26. The wire bonding apparatus also includes capstan member 30 for guiding wire W from spool 14 as the wire is unwound from spool 14. Capstan member 30 is supported by capstan arm 32 bolted to spool mounting structure 26.

Referring to FIGS. 1, 2 and 7 through 9, portion 34 of the wire bonding apparatus is mounted to Y-axis slide casting 20 for movement along the Y-axis of the XY bond plane. As a result, the wire bonding components included in Y-axis portion 34 may be translated along both the X and Y axes of the XY bond plane because of the sliding support of Y-axis slide casting 20 on X-axis slide member 16.

Y-axis portion 34 of the wire bonding apparatus includes slack loop air guide 36 adapted to receive wire W from spool 14 and form the wire into a curved configuration having substantially uniform tension throughout. Slack loop air guide 36 includes laminar flow plates 38, 40, 42. Laminar flow plate 38 is supported on an upper surface of laminar flow plate 40. As shown in FIG. 1, laminar flow plate 40 extends along the Y-axis beyond an end of laminar flow plate 38 such that the upper surface of plate 40 defines a first laminar airflow area 44. Laminar flow plate 40 is, in turn, supported on an upper surface of laminar flow plate 42. As shown, plate 42 extends along the X-axis beyond an end of plate 40 such that the upper surface of plate 42 defines second laminar airflow area 46.

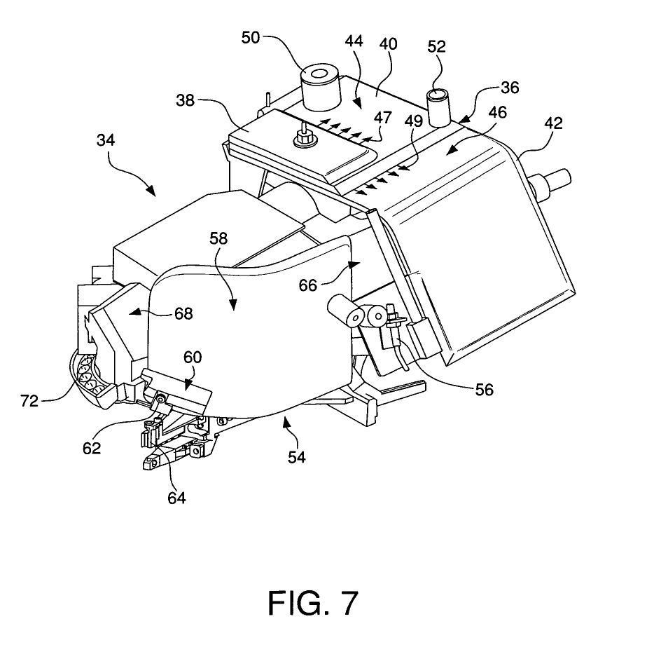

Referring to FIGS. 1 and 7, slack loop air guide 36 operates in the following manner to form wire W into a slack loop configuration such as that shown in FIG. 1. Air from an air supply system (not shown) is directed between plates 38, 40 into first laminar airflow area 44 in flow of air 47 that is directed substantially parallel to the Y-axis. Wire W is received on the upper surface of plate 40 from spool 14 such that the wire is transversely impinged by the laminar flow of air along the Y-axis across the upper surface of plate 40. The impingement by the laminar airflow in area 44 directs wire W laterally away from plate 38 as shown in FIG. 1. First and second cylinders 50, 52 are connected to the upper surface of plate 40 and located such that wire W, as shown in FIG. 1, is located between plate 38 and cylinders 50, 52. The amount of potential movement of wire W away from plate 38, therefore, is limited by cylinders 50, 52. Wire W is then directed from first laminar airflow area 44 to the upper surface of plate 42. Air is also directed from the air supply system (not shown) in a flow of air 49 to second laminar airflow area 46 from between plates 40, 42. As shown in FIG. 7, airflow 49 in second laminar airflow area 46 is directed along the X-axis such that airflows 47, 49 are substantially perpendicular to each other. The laminar flow of air in second laminar airflow area 46 provides a secondary flow of air that balances and dampens the wire W as it is directed from slack loop air guide 36 to wire tensioner 54.

Wire feed system 12 includes feed sensor 56 located between plate 42 of slack loop air guide 36 and plate 58 of wire tensioner 54. Feed sensor 56 is arranged to indicate proximity between wire tensioner 54 and the bonding wire W when a sufficient amount of wire has been fed to slack loop air guide 36 from spool 14 to form the wire into a slack loop configuration such as that shown in FIG. 1. Wire is directed along plate 42, which includes a bend, to extend downwardly (with respect to the view of FIG. 7), past wire feed sensor 56. During steady state conditions, wire W is balanced on opposite sides of wire feed sensor 56 between slack loop air guide 36 and wire tensioner 54, which is described in greater detail below. During a wire bonding process, the wire W will be received by wire tensioner 54 from slack loop air guide 36 such that the length of wire W in slack loop air guide 36 will be shortened. As a result, the portion of the wire W that is moving past the wire sensor will move upwardly, away from wire sensor 56. When the wire W has been moved away from wire sensor 56 to the extent that wire sensor 56 no longer indicates proximity between wire feed sensor 56 and the wire W, wire feed system 12 directs spool drive motor 28 to feed wire from spool 14 to slack loop air guide 36 until the slack loop configuration returns the wire to the balanced condition in which wire W is located adjacent wire feed sensor 56.

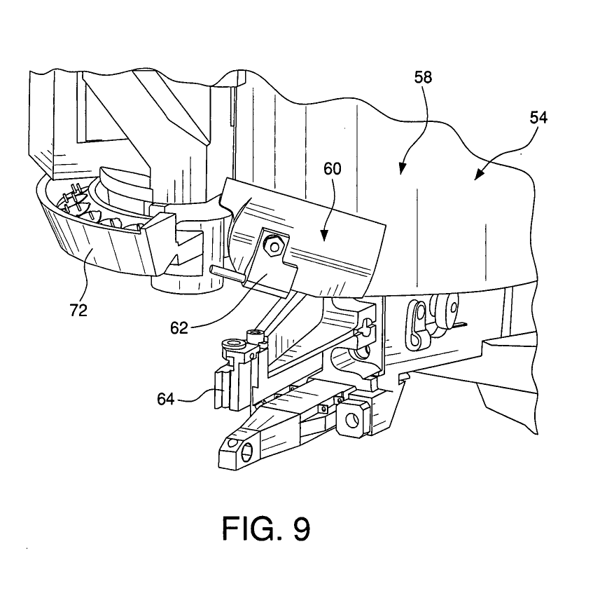

Wire tensioner 54 of Y-axis portion 34 of bond head 10 includes laminar airflow plate 58. Wire tensioner 54 also includes laminar air flow generator 60 and wire guide 62 (see FIG. 7). As shown in FIG. 9, a transducer and capillary mount structure 64 of Y-axis bond head portion 34 is located in a lower front part of bond head 10 for receipt of a transducer and capillary (not shown) of bond head 10. The wire from spool 14 extends across plate 58 of wire tensioner 54 and is received by wire guide 62, which directs the wire into the capillary of bond head 10. Air from an air supply (not seen) is directed from laminar airflow generator 60 onto the inner surface of laminar airflow plate 58. The air flowing along the surface of plate 58 from generator 60 impinges on the wire resulting in tensioning of the wire. For example, wire tensioner 54 may be in the above-described balanced condition with slack loop air guide 36 during steady state conditions. As wire is being used in the bonding process, however, wire tensioner 54 will exert a greater pressure on the wire than slack loop air guide 36 to pull the wire forward. Following the advancement of the wire, the pressure between the two wire systems will return to a balanced condition.

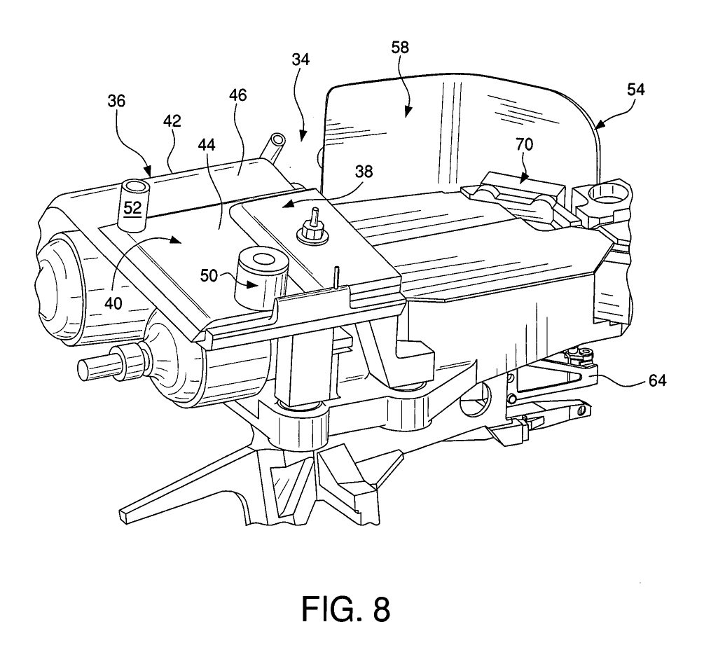

The illustrated exemplary wire bonding apparatus also includes a vision system carried by Y-axis portion 34 of bond head 10. The vision system includes camera 66 (FIG. 7) having lens housing 68 located forwardly on Y-axis portion 34 of bond head 10. The vision system also includes mirror housing 70 (FIG. 8). The vision system further includes LED mount 72 located adjacent lens housing 68 of camera 66.

Relative movement between slack loop air guide 36 and wire tensioner 54 is eliminated (or substantially eliminated) in the bonding apparatus of the present invention because, as described above, both of these components are included in Y-axis portion 34 of bond head 10. As mentioned above, the elimination of relative movement between these feed system components desirably reduces the length of wire maintained between spool 14 and the capillary and also reduces the amount of working that the wire is subjected to.

As described above, spool mounting structure 26 is attached to X-axis slide member 16 of bond head 10 such that spool 14 of wire feed system 12 is moved along the X-axis of the XY bond plane. Therefore, there will be some relative movement between spool 14 of feed system 12 and the capillary of the bond head 10, which moves along both the X and Y axes of the XY bond plane. However, because spool 14 is carried by bond head 10 with respect to the X-axis movement, the relative movement that occurs between spool 14 and the capillary of bond head 10 is reduced (e.g., substantially reduced by an approximately 50%) compared to that of prior wire bonding apparatuses, such as the apparatus of U.S. Pat. No. 5,402,927 (to Frasch), in which the spool was fixed with respect to both the X and Y axes movement of the capillary.

It is also contemplated that the X and Y axes need not be configured to carry one another (e.g., the X-axis does not need to carry the Y-axis.) On the contrary, the present invention is directly applicable alternative configurations, for example, a split axis machine where the spool is in a fixed position relative to the Y-axis. In such an instance, laminar air flow may be used to carry the wire in the Y-axis, thus permitting the X-axis to be totally independent.

The foregoing describes the invention in terms of embodiments foreseen by the inventor for which an enabling description was available, notwithstanding that insubstantial modifications of the invention, not presently foreseen, may nonetheless represent equivalents thereto.

What is claimed is:

1. A wire feed system for a wire bonding apparatus:
a spool for storage of a wire;
a wire tensioner; and
a wire guide adapted to form the wire into a predetermined configuration between the spool and the wire tensioner,
the wire tensioner and the wire guide supported such that relative movement between the wire tensioner and the wire guide during a wire bonding procedure is substantially prevented.

2. The wire feed system according to claim 1 further comprising a support structure including an X-axis mechanism adapted to provide movement along an X-axis of an X-Y working plane and a Y-axis mechanism adapted to provide movement along a Y-axis of the X-Y working plane, wherein the wire tensioner and the wire guide are both carried by the Y-axis mechanism.

3. The wire feed system according to claim 2, wherein the spool is carried by the X-axis mechanism.

4. The wire feed system according to claim 3, wherein the Y-axis mechanism is carried by the X-axis mechanism.

5. The wire feed system according to claim 4, wherein the X-axis mechanism includes a slide member on which the Y-axis mechanism is slidingly supported.

6. The wire feed system according to claim 1, wherein the wire guide includes a laminar airflow mechanism adapted to direct air to a laminar airflow area to transversely impinge the wire.

7. The wire feed system according to claim 6, wherein the laminar airflow mechanism includes an air supply system and first and second plates having surfaces respectively defining first and second laminar airflow areas, and wherein the air supply system is adapted to direct air to the first and second laminar airflow areas such that a flow of air in the first laminar airflow area is substantially perpendicular to a flow of air in the second laminar airflow area.

8. The wire feed system according to claim 1, wherein the wire tensioner includes an airflow generator adapted to direct air against the wire to tension the wire.

9. The wire feed system according to claim 1, further comprising a wire sensor located between the wire guide and the wire tensioner, the wire feed system controlling a spool drive motor for driving the spool in response to feedback from the wire sensor to direct wire from the spool to the wire guide after wire is drawn to the wire tensioner from the predetermined wire configuration at the wire guide.

10. A bond head for a wire bonding machine, the bond head comprising:
a spool for storage of wire; and
a first moveable support structure configured for moving at least a portion of the bond head along a first axis, the portion of the bond head including the spool.

11. The bond head of claim 10 wherein the first axis is a horizontal axis, the a first moveable support structure being configured for translation along the first axis.

12. The bond head of claim 11 wherein the first axis is an X-axis of motion.

13. The bond head of claim 11 additionally comprising a second moveable support structure configured for moving at least another portion of the bond head along a second horizontal axis.

14. The bond head of claim 13 wherein the second horizontal axis is a Y-axis of motion.

15. The bond head of claim 13 wherein the another portion of the bond head does not include the spool.

16. The bond head of claim 15 wherein the portion of the bond head includes a wire tensioner and a wire guide, and the another portion of the bond head includes the wire tensioner and the wire guide.

17. A wire bonding apparatus comprising:
a bond head including a capillary adapted to receive a wire, the bond head movably supported for translation in an X-Y working plane during a wire bonding procedure;
a wire tensioner for tensioning the wire received by the capillary as the capillary moves in the X-Y plane; and
a wire guide adapted to form the wire into a predetermined configuration, the wire guide and the wire tensioner being supported with the bond head for movement with respect to the X-Y working plane so as to substantially inhibit relative movement between the wire guide and the wire tensioner during a wire bonding procedure.

18. The wire bonding apparatus according to claim 17, further comprising a support structure including an X-axis mechanism and a Y-axis mechanism respectively providing movement along the X and Y axes of the X-Y working plane, wherein the wire tensioner and the wire guide are both carried by the Y-axis mechanism.

19. The wire bonding apparatus according to claim 18, wherein the Y-axis mechanism is carried by the X-axis mechanism.

20. The wire bonding apparatus according to claim 18, further comprising a rotatably supported spool for supplying wire.

21. The wire bonding apparatus according to claim 20, wherein the spool is carried by the X-axis mechanism.

22. A wire feed system for a wire bonding machine comprising:
a slack loop device including an airflow mechanism adapted to direct a flow of air against a bonding wire received from a wire supply so as to form the wire into a slack loop configuration; and
a wire tensioner adapted to receive the bonding wire from the slack loop device and apply tension to the bonding wire,
the wire tensioner and the slack loop device supported such that relative movement between the wire tensioner and the slack loop device during a wire bonding procedure is substantially inhibited.

23. The wire feed system according to claim 22 further comprising a spool adapted for winding receipt of a length of bonding wire to provide the wire supply.

24. The wire feed system according to claim 23 further comprising a spool drive motor connected to the spool for delivering the bonding wire to the slack loop device, the wire feed system further including a wire sensor adapted to indicate proximity between the wire sensor and the bonding wire, the wire sensor located between the slack loop device and the wire tensioner, the wire sensor arranged so that receipt of the bonding wire by the wire tensioner from the slack loop device results in movement of the bonding wire away from the wire sensor, wherein the wire feed system is adapted to control the spool drive motor to deliver the bonding wire to the slack loop device when the wire sensor is not indicating proximity between the bonding wire and the wire sensor.

25. The wire feed system according to claim 22, wherein the airflow mechanism of the slack loop device includes first and second plates having surfaces respectively defining first and second laminar airflow areas, and wherein the airflow mechanism is adapted to direct air to the first and second laminar airflow areas such that a flow of air in the first laminar airflow area is substantially perpendicular to a flow of air in the second laminar airflow area.
